(19) United States
(12) Patent Application Publication
(10) Pub. No.: US 2017/0200024 A1
(43) Pub. Date: Jul. 13, 2017

(54) ELECTRONIC DEVICE AND METHOD OF SECURING THE SAME

(71) Applicant: Samsung Electronics Co., Ltd., Gyeonggi-do (KR)

(72) Inventors: Soyeon Kim, Suwon-si (KR); Daewoong Song, Suwon-si (KR); Eojin Lim, Suwon-si (KR); Youngtae Jin, Hwaseong-si (KR); Seongyeon Hwang, Suwon-si (KR); Soojung Lee, Seongnam-si (KR)

(21) Appl. No.: 15/397,365

(22) Filed: Jan. 3, 2017

(30) Foreign Application Priority Data
Jan. 8, 2016 (KR) 10-2016-0002654
Sep. 21, 2016 (KR) 10-2016-0120545

(51) Int. Cl. G06F 21/84; G06F 3/16; G06F 21/60; G06F 3/01

(52) U.S. Cl. CPC G06F 21/84; G06F 3/017; G06F 3/167; G06F 21/604

(57) ABSTRACT

An electronic device and a method of securing the electronic device are provided. The method includes displaying content and recognizing at least one of a tilt, a sound, or a voice. Then, comparing preset reference data to at least one of an angle corresponding to the tilt, data corresponding to the sound, or data corresponding to the voice. Further, activating a secure mode for the displayed content, when the at least one of the angle corresponding to the tilt, the data corresponding to the sound, or the data corresponding to the voice is consistent with the preset reference data. Another embodiment includes displaying content, recognizing a connection with an external electronic device, and activating a secure mode for the displayed content, in response to the recognized connection. Additional features may include requesting the connected external electronic device to display the content, and then altering and displaying the altered content thereon.

### CROSS-REFERENCE TO RELATED APPLICATION(S) AND CLAIM OF PRIORITY

The present application is related to and claims the priority under 35 U.S.C. §119(a) of Korean patent application filed on Jan. 8, 2016 and Sep. 21, 2016 in the Korean Intellectual Property Office and assigned Serial number 10-2016-0002654 and 10-2016-0120545 respectively, the entire disclosure of which is hereby incorporated by reference.

### TECHNICAL FIELD

Various embodiments of the present disclosure relate to an electronic device and a method of securing the electronic device.

### BACKGROUND

Electronic devices are referred to as apparatuses configured to perform functions according to corresponding applications. Examples of electronic devices are home appliances, electronic organizers, portable multimedia players, mobile communication terminals, tablet PCs, video/audio systems, desktop PCs, laptop PCs, vehicle navigation systems, etc. As the degree of integration of electronic components in electronic devices increases and wireless communication for high speed data and large traffic becomes common, electronic devices have been equipped with various functions.

Electronic devices with various functions are capable of storing and displaying various information regarding users to provide user convenience. However, with the increase in the understanding of the protection of personal information, electronic device users have used various methods to secure information displayed on the screen of the electronic devices from being revealed to nearby people. Examples of the secure methods are the attachment of a secure film to the screen of the electronic device, the attenuation of brightness of the screen, the decrease in font size on the screen, etc.

However, these methods are disadvantageous because using secure films requires users to spend additional expenses, and attenuating the brightness of the screen or decreasing the font size causes user inconvenience.

### SUMMARY

To address the above-discussed deficiencies, it is a primary object to provide a method that allows an electronic device, which is outputting content, to provide a user with only part of the content that the user desires to use; or part of the content which differs from content of other nearby users. Consequently, the method causes a reduction of additional expenses and aides in reducing and/or removing user inconvenience. Various embodiments of the present disclosure provide an electronic device adapted to perform this method.

In accordance with an embodiment of the present disclosure, a method of securing an electronic device is provided. The method includes displaying content; recognizing at least one of the tilt, sound and voice; comparing at least one of: an angle corresponding to the tilt, data corresponding to the sound and data corresponding to the voice with preset reference data; and activating secure mode for the content, when at least one of: an angle corresponding to the tilt, data corresponding to the sound, and data corresponding to the voice is consistent with preset reference data.

In accordance with another embodiment of the present disclosure, a method of securing an electronic device is provided. The method includes displaying content; recognizing the connection with an external electronic device; and activating secure mode for the content, when the electronic device is connected with the external electronic device.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a network environment including an electronic device according to various embodiments of the present disclosure;

FIG. 2 illustrates a block diagram of an electronic device according to various embodiments of the present disclosure;

FIG. 3 illustrates a block diagram of a program module according to various embodiments of the present disclosure;

FIG. 4 is a flowchart that illustrates operations of an electronic device according to various embodiments of the present disclosure;

FIG. 5 illustrates a diagram of a method of setting reference data according to various embodiments of the present disclosure;

FIG. 6 illustrates a diagram of a method of setting reference data according to various embodiments of the present disclosure;

FIG. 7 illustrates a diagram of a method of setting reference data according to various embodiments of the present disclosure;

FIG. 8 illustrates a diagram of operating in a secure mode according to various embodiments of the present disclosure;

FIG. 9 illustrates an electronic device and an external electronic device according to various embodiments of the present disclosure;

FIG. 10 illustrates operating of an electronic device connected to an external electronic device according to various embodiments of the present disclosure; and

FIG. 11 illustrates operating of an electronic device connected to an external electronic device according to various embodiments of the present disclosure.

### DETAILED DESCRIPTION

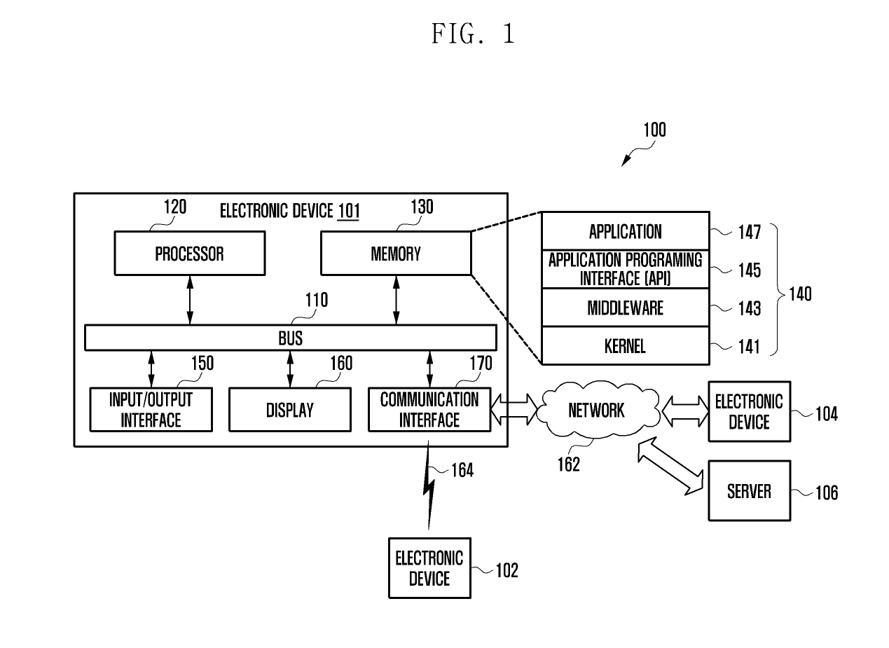

FIGS. 1 through 11, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged electronic device.

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The term “include” or “may include” which may be used in describing various embodiments of the present disclosure refers to the existence of a corresponding disclosed function, operation or component which can be used in various embodiments of the present disclosure and does not limit one or more additional functions, operations, or components. In various embodiments of the present disclosure, the terms such as “include” or “have” may be construed to denote a certain characteristic, number, operation, constituent element, component or a combination thereof but may not be construed to exclude the existence of or a possibility of the addition of one or more other characteristics, numbers, operations, constituent elements, components or combinations thereof.

In various embodiments of the present disclosure, the expression “or” or “at least one of A or/and B” includes any or all of combinations of words listed together. For example, the expression “A or B” or “at least A or/and B” may include A, may include B, or may include both A and B.

The expression “1”, “2”, “first”, or “second” used in various embodiments of the present disclosure may modify various components of the various embodiments but does not limit the corresponding components. For example, the above expressions do not limit the sequence and/or importance of the components. The expressions may be used for distinguishing one component from other components. For example, a first user device and a second user device may indicate different user devices although both of them are user devices. For example, without departing from the scope of the present disclosure, a first structural element may be referred to as a second structural element. Similarly, the second structural element also may be referred to as the first structural element.

When it is stated that a component is “coupled to” or “connected to” another component, the component may be directly coupled or connected to another component or a new component may exist between the component and another component. In contrast, when it is stated that a component is “directly coupled to” or “directly connected to” another component, a new component does not exist between the component and another component.

Unless defined differently, all terms used herein, which include technical terminologies or scientific terminologies, have the same meaning as that understood by a person skilled in the art to which the present disclosure belongs. Such terms as those defined in a generally used dictionary are to be interpreted to have the meanings equal to the contextual meanings in the relevant field of art, and are not to be interpreted to have ideal or excessively formal meanings unless clearly defined in the present description.

An electronic device according to various embodiments of the present disclosure may be a device including a communication function. For example, the electronic device may be one or a combination of a smart phone, a tablet personal computer (PC), a mobile phone, a video phone, an e-book reader, a desktop PC, a laptop PC, a netbook computer, a personal digital assistant (PDA), a camera, and a wearable device (e.g., a head-mounted-device (HMD) such as electronic glasses; electronic clothes; an electronic bracelet; an electronic necklace; an electronic accessary; an electronic tattoo; and a smart watch).

According to some embodiments, the electronic device may be a smart home appliance having a communication function. The smart home appliance may include at least one of a television (TV), a digital versatile disc (DVD) player, an audio player, an air conditioner, a cleaner, an oven, a microwave oven, a washing machine, an air cleaner, a set-top box, a TV box (e.g., Samsung HomeSync®, Apple TVT®, or Google TV®), game consoles, an electronic dictionary, an electronic key, a camcorder, and an electronic frame.

According to some embodiments, the electronic device may include at least one of various types of medical devices (e.g., magnetic resonance angiography (MRA), magnetic resonance imaging (MRI), computed tomography (CT), a scanner, an ultrasonic device and the like), a navigation device, a global navigation satellite system (GNSS) receiver, an event data recorder (EDR), a flight data recorder (FDR), a vehicle infotainment device, electronic equipment for a ship (e.g., a navigation device for ship, a gyro compass and the like), avionics, a security device, a head unit for a vehicle, an industrial or home robot, an automatic teller machine (ATM) of financial institutions, a point of sale (POS) device of shops, and a device for internet of things (IoT) (e.g., a fire alarm, various sensors, electric or gas meter units, a sprinkler, a thermostat, a streetlamp, a toaster, sport outfits, a hot-water tank, a heater, a boiler and the like).

According to some embodiments, the electronic device may include at least one of furniture or a part of a building/structure, an electronic board, an electronic signature receiving device, a projector, and various types of measuring devices (e.g., a water meter, an electricity meter, a gas meter, a radio wave meter and the like) including a camera function. The electronic device according to various embodiments of the present disclosure may be one or a combination of the above described various devices. Further, the electronic device according to various embodiments of the present disclosure may be a flexible device. It is apparent to those skilled in the art that the electronic device according to various embodiments of the present disclosure is not limited to the above described devices.

Hereinafter, an electronic device according to various embodiments of the present disclosure will be described with reference to the accompanying drawings. The term “user” used in various embodiments may refer to a person who uses an electronic device or a device (e.g., an artificial intelligence electronic device) which uses an electronic device.

FIG. 1 illustrates a network environment 100 including an electronic device 101 according to an embodiment of the present disclosure.

Referring to FIG. 1, the electronic device 101 may include various components including a bus 110, a processor 120, a memory 130, an input/output interface 150, a display 160, a communication interface 170, and a power management module (not shown in FIG. 1).

The bus 110 may be a circuit connecting the above described components and transmitting communication (e.g., a control message) between the above described components.

The processor 120 may receive commands from other components (e.g., the memory 130, the input/output interface 150, the display 160, the communication interface 170, or the power management module) through the bus 110, analyze the received commands, and execute calculation or data processing according to the analyzed commands.

The memory 130 stores commands or data received from the processor 120 or other components (e.g., the input/output interface 150, the display 160, the communication interface 170, or the power management module) or generated by the processor 120 or other components. The memory 130 may store a software and/or a program. For example, the program 140 may include a kernel 141, middleware 143, an application programming interface (API) 145, and an application program (or an application) 147. At least part of the kernel 141, the middleware 143 or the API 145 may refer to an operating system (OS).

The kernel 141 controls or manages system resources (e.g., the bus 110, the processor 120, or the memory 130) used for executing an operation or function implemented by the remaining other programming modules, for example, the middleware 143, the API 145, or the application 147. Further, the kernel 141 provides an interface for accessing individual components of the electronic device 101 from the middleware 143, the API 145, or the application 147 to control or manage the components.

The middleware 143 performs a relay function of allowing the API 145 or the application 147 to communicate with the kernel 141 to exchange data. Further, in operation requests received from the application 147, the middleware 143 performs a control for the operation requests (e.g., scheduling or load balancing) by using a method of assigning a priority, by which system resources (e.g., the bus 110, the processor 120, the memory 130 and the like) of the electronic device 101 can be used, to the application 147.

The API 145 is an interface by which the application 147 can control a function provided by the kernel 141 or the middleware 143 and includes, for example, at least one interface or function (e.g., command) for a file control, a window control, image processing, or a character control.

According to various embodiments, the application 147 may include a short message service (SMS)/multimedia messaging service (MMS) application, an email application, a calendar application, an alarm application, a health care application (e.g., application measuring quantity of exercise or blood sugar) or an environment information application (e.g., application providing information on barometric pressure, humidity or temperature). Additionally, or alternatively, the application 147 may be an application related to an information exchange between the electronic device 101 and an external electronic device (e.g., electronic device 102). The application 147 related to the information exchange may include, for example, a notification relay application for transferring particular information to the external electronic device or a device management application for managing the external electronic device.

For example, the notification relay application may include a function of transmitting notification information generated by another application (e.g., an SMS/MMS application, an email application, a health care application or an environment information application) of the electronic device 101 to the external electronic device (e.g., electronic device 102 or electronic device 104). Additionally, or alternatively, the notification relay application may receive notification information from, for example, the external electronic device 109B, and provide the received notification information to the user. The device management application may manage (e.g., install, remove, or update) at least a part of functions of the electronic device. For example, the device management application may turn on/off the external electronic device (or some components of the external electronic device), control a brightness of the display of the external electronic device or communicate with the electronic device 101, an application executed in the external electronic device 102, or a service (e.g., call service or message service) provided by the external electronic device 102.

According to various embodiments, the application 147 may include an application designated according to an attribute (e.g., type of electronic device) of the external electronic device 102. For example, when the external electronic device 102 is a Moving Picture Experts Group phase 1 or phase 2 (MPEG-1 or MPEG-2) audio layer 3 (MP3) player, the application 147 may include an application related to music reproduction. Similarly, when the external electronic device 102 is a mobile medical device, the application 147 may include an application related to health care. According to an embodiment, the application 147 may include at least one of an application designated to the electronic device 101 and an application received from an external electronic device (e.g., server 106 or electronic device 104).

The input/output interface 150 transmits a command or data input from the user through an input/output device 150 (e.g., a sensor, a keyboard, or a touch screen) to the processor 120, the memory 130, the communication interface 170, or the display control module 160 through, for example, the bus 110. For example, the input/output interface 150 may provide data on a user's touch input through a touch screen to the processor 120. Further, the input/output interface 150 may output a command or data received through, for example, the bus 110, from the processor 120, the memory 130, the communication interface 170, or the power management module through the input/output device (e.g., a speaker or a display). For example, the input/output interface 150 may output voice data processed through the processor 120 to the user through the speaker.

The display 160 may include, for example, liquid crystal display (LCD), flexible display, transparent display, light-emitting diode (LED) display, organic LED (OLED) display, microelectromechanical systems (MEMS) display, or electronic paper display. The display 160 may visually offer, for example, various contents (e.g., text, image, video, icon, symbol, etc.) to users. The display 160 may include a touch screen and receive, for example, a touch, gesture, proximity, or hovering input using an electronic pen or a user's body. According to an embodiment, the display 160 may be one or more displays. For example, the display 160 may be included in the electronic device 101 or included in an external device (e.g., the electronic device 102 or 104) having a wired or wireless connection with the electronic device 101, thus outputting information offered by the electronic device 101 to users.

According to an embodiment, the display 160 may be attachable to or detachable from the electronic device 101. For example, the display 160 may include an interface which can be mechanically or physically connected with the electronic device 101. According to an embodiment, in case the display 160 is detached (e.g., separated) from the electronic device 101 by a user's selection, the display 160 may receive various control signals or image data from the power management module or the processor 120, e.g., through wireless communication.

The communication interface 170 may establish communication between the electronic device 101 and any external device (e.g., the first external electronic device 102, the second external electronic device 104, or the server 106). For example, the communication interface 170 may be connected with a network 162 through wired or wireless communication and thereby communicate with any external device (e.g., the first external electronic device 102, the second external electronic device 104, or the server 106).

According to an embodiment, the electronic device 101 may be connected with the first external electronic device 102 and the second external electronic device 104 without using the communication interface 170. For example, based on at least one of a magnetic sensor, a contact sensor, a light sensor, and the like that is equipped in the electronic device 101, the electronic device 101 may sense whether at least one of the first and second external electronic devices 102 and 104 is contacted with at least part of the electronic device 101, or whether at least one of the first and second external electronic device 102 and 104, respectively, is attached to at least part of the electronic device 101.

Wireless communication may use, as cellular communication protocol, at least one of long-term evolution (LTE), LTE advanced (LTE-A), code division multiple access (CDMA), wideband CDMA (WCDMA), universal mobile telecommunications system (UMTS), wireless broadband (WiBro), global system for mobile communications (GSM), and the like, for example. A short-range communication 164 may include, for example, at least one of Wi-Fi, Bluetooth®, near field communication (NFC), magnetic secure transmission or near field magnetic data stripe transmission (MST), GNSS, and the like. The GNSS may include at least one of, for example, a global positioning system (GPS), a global navigation satellite system (GLONASS®), a BeiDou® Navigation Satellite System (hereinafter, referred to as “BeiDou”), and Galileo® (European global satellite-based navigation system). Hereinafter, the “GPS” may be interchangeably used with the “GNSS” in the present disclosure. Wired communication may include, for example, at least one of universal serial bus (USB), high definition multimedia interface (HDMI), recommended standard-232 (RS-232), plain old telephone service (POTS), and the like. The network 162 may include telecommunication network, for example, at least one of a computer network (e.g., local area network (LAN) or wide area network (WAN)), internet, and a telephone network.

The first and second external electronic devices 102 and 104 may be identical to, or different from, the electronic device 101. According to an embodiment, the first and second external electronic devices 102 and 104 may include, for example, a plurality of electronic devices. According to an embodiment, the server 106 may include a single server or a group of servers. According to various embodiments, all or part of operations executed in the electronic device 101 may be executed in other electronic device(s), such as the first and second electronic devices 102 and 104 or the server 106.

According to an embodiment, the electronic device 101 may be required to perform a certain function or service automatically or by request, the electronic device 101 may request another device (e.g., the electronic device 102 or 104 or the server 106) to execute instead, or additionally at least part, of at least one or more functions associated with the required function or service. The requested device may execute the requested function and deliver the result of execution to the electronic device 101. Then, the electronic device 101 may offer the required function or service, based on the received result or by processing the received result. For the above, cloud computing technology, distributed computing technology, or client-server computing technology may be used, for example.

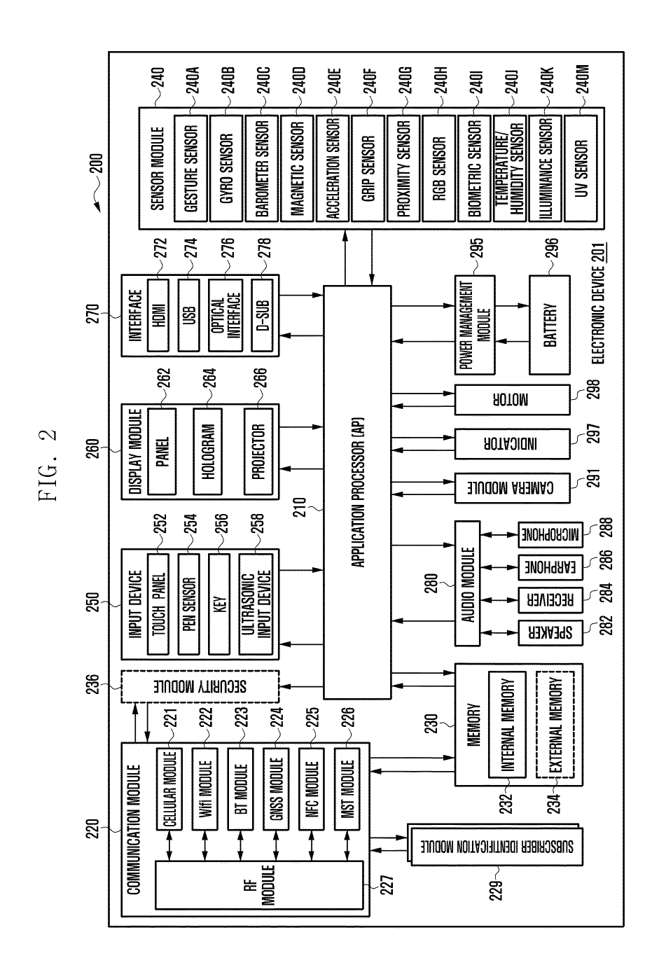

FIG. 2 is a detailed block diagram showing a configuration of an electronic device 201 according to an embodiment of the present disclosure. For example, the electronic device 201 is capable of including part or all of the components in the electronic device 101 shown in FIG. 1.

Referring to FIG. 2, the electronic device 201 is capable of including one or more processors 210 (e.g., application processors (APs) 210), a communication module 220, a subscriber identification module (SIM) 229, a memory 230, a security module 236, a sensor module 240, an input device 250, a display 260, an interface 270, an audio module 280, a camera module 291, a power management module 295, a battery 296, an indicator 297, and a motor 298.

The processor 210 is capable of driving, for example, an OS or an application program to control a plurality of hardware or software components connected to the processor 210, processing various data, and performing operations. The processor 210 may be implemented as, for example, a system on chip (SoC). According to an embodiment, the processor 210 may further include a graphics processing unit (GPU) and/or an image signal processor. The processor 210 may also include at least part of the components shown in FIG. 2, e.g., a cellular module 221. The processor 210 is capable of loading commands or data received from at least one of other components (e.g., a non-volatile memory) on a volatile memory, processing the loaded commands or data. The processor 210 is capable of storing various data in a non-volatile memory.

The communication module 220 may include the same or similar configurations as the communication interface 170 shown in FIG. 1. For example, the communication module 220 is capable of including a cellular module 221, Wi-Fi module 222, Bluetooth® module 223, GNSS module 224 (e.g., a GPS module, GLONASS® module, BeiDou® module or Galileo® module), NFC module 225, MST module 226, and radio frequency (RF) module 227.

The cellular module 221 is capable of providing a voice call, a video call, an SMS service, an internet service, etc., through a communication network, for example. According to an embodiment, the cellular module 221 is capable of identifying and authenticating an electronic device 201 in a communication network by using a SIM 229 (e.g., a SIM card). According to an embodiment, the cellular module 221 is capable of performing at least part of the functions provided by the processor 210. According to an embodiment, the cellular module 221 is also capable of including a communication processor (CP).

Each of the Wi-Fi module 222, the Bluetooth® module 223, the GNSS module 224, and the NFC module 225 is capable of including a processor for processing data transmitted or received through the corresponding module. The MST module 226 is capable of including a processor for processing data transmitted or received through the corresponding module. According to various embodiments, at least part of the cellular module 221, Wi-Fi module 222, Bluetooth module 223, GNSS module 224, NFC module 225, and MST module 226 (e.g., two or more modules) may be included in one integrated chip (IC) or one IC package.

The RF module 227 is capable of transmission/reception of communication signals, e.g., RF signals. The RF module 227 is capable of including a transceiver, a power amp module (PAM), a frequency filter, a low noise amplifier (LNA), an antenna, etc. According to an embodiment, at least one of the following modules: cellular module 221, Wi-Fi module 222, Bluetooth module 223, GNSS module 224, NFC module 225, and MST module 226 is capable of transmission/reception of RF signals through a separate RF module.

The SIM module 229 is capable of including a card including a SIM and/or an embodied SIM. The SIM module 229 is also capable of containing unique identification information, e.g., integrated circuit card identifier (ICCID), or subscriber information, e.g., international mobile subscriber identity (IMSI).

The memory 230 (e.g., memory 130 shown in FIG. 1) is capable of including a built-in memory 232 or an external memory 234. The built-in memory 232 is capable of including at least one of the following: a volatile memory, e.g., a dynamic random access memory (DRAM), a static RAM (SRAM), a synchronous DRAM (SDRAM), etc.; and a non-volatile memory, e.g., a one-time programmable read only memory (OTPROM), a programmable ROM (PROM), an erasable and programmable ROM (EPROM), an electrically erasable and programmable ROM (EEPROM), a mask ROM, a flash ROM, a flash memory (e.g., an NAND flash memory, an NOR flash memory, etc.), a hard drive, a solid state drive (SSD), etc.

The external memory 234 is also capable of including a flash drive, e.g., a compact flash (CF), a secure digital (SD), a micro-SD, a mini-SD, an extreme digital (xD), a multi-media card (MMC), a memory stick, etc. The external memory 234 is capable of being connected to the electronic device 201, functionally and/or physically, through various interfaces.

The memory 230 is capable of storing payment information and a payment application serving as one of the application programs 147. The payment information may refer to credit card numbers and personal identification numbers (PINs), corresponding to a credit card. The payment information may also include user authentication information, e.g., fingerprints, facial features, voice information, etc.

When the payment application is executed by the processor 210, it may enable the processor 210 to perform: an interaction with the user to make payment (e.g., displaying a screen to select a card (or a card image) and obtaining information (e.g., a card number) corresponding to a selected card (e.g., a pre-specified card) from payment information); and an operation to control magnetic field communication (e.g., transmitting the card information to an external device (e.g., a card reading apparatus) through the NFC module 225 or MST module 226).

The security module 236 may include a storage of which a security level is higher than a security level of the memory 230 and circuits for supporting that data is safely stored in the storage and used by other components such as the processor 210. The security module 236 may further include a processor separate from the processor 210. The security module 236 may be embedded in, for example, a detachable smart chip or an SD. The security module may include an embedded secure element (eSE) embedded in some chip of the electronic device 201. The security module 236 may be operated by an OS such as java card open platform (JCOP) different from the OS shown in FIG. 1.

The sensor module 240 is capable of measuring/detecting a physical quantity or an operation state of the electronic device 201, and converting the measured or detected information into an electronic signal. The sensor module 240 is capable of including at least one of the following: a gesture sensor 240A, a gyro sensor 240B, an atmospheric or barometric pressure sensor 240C, a magnetic sensor 240D, an acceleration sensor 240E, a grip sensor 240F, a proximity sensor 240G, a color sensor 240H (e.g., a red, green and blue (RGB) sensor), a biometric sensor 240I, a temperature/humidity sensor 240J, an illuminance sensor 240K, and an ultraviolet (UV) sensor 240M. Additionally or alternatively, the sensor module 240 is capable of further including an E-nose sensor, an electromyography (EMG) sensor, an electroencephalogram (EEG) sensor, an electrocardiogram (ECG) sensor, an infrared (IR) sensor, an iris sensor and/or a fingerprint sensor. The sensor module 240 is capable of further including a control circuit for controlling one or more sensors included therein. In embodiments, the electronic device 201 is capable of including a processor, configured as part of the processor 210 or a separate component, for controlling the sensor module 240. In this case, while the processor 210 is operating in sleep mode, the processor is capable of controlling the sensor module 240.

The input device 250 is capable of including a touch panel 252, a (digital) pen sensor 254, a key 256, or an ultrasonic input unit 258. The touch panel 252 may be implemented with at least one of the following: a capacitive touch system, a resistive touch system, an IR touch system, and an ultrasonic touch system. The touch panel 252 may further include a control circuit. The touch panel 252 may also further include a tactile layer to provide a tactile response to the user.

The (digital) pen sensor 254 may be implemented with a part of the touch panel or with a separate recognition sheet. The key 256 may include a physical button, an optical key, or a keypad. The ultrasonic input unit 258 is capable of detecting ultrasonic waves, created in an input tool, through a microphone 288, and identifying data corresponding to the detected ultrasonic waves.

The display 260 (e.g., the display 160 shown in FIG. 1) is capable of including a panel 262, a hologram unit 264, or a projector 266. The panel 262 may include the same or similar configurations as the display 160 shown in FIG. 1. The panel 262 may be implemented to be flexible, transparent, or wearable. The panel 262 may also be incorporated into one module together with the touch panel 252. The hologram unit 264 is capable of showing a stereoscopic image in the air by using light interference. The projector 266 is capable of displaying an image by projecting light onto a screen. The screen may be located inside or outside of the electronic device 201. According to an embodiment, the display 260 may further include a control circuit for controlling the panel 262, the hologram unit 264, or the projector 266.

The interface 270 is capable of including an HDMI 272, a USB 274, an optical interface 276, or a D-subminiature (D-sub) 278. The interface 270 may be included in the communication interface 170 shown in FIG. 1. Additionally or alternatively, the interface 270 is capable of including a mobile high-definition link (MHL) interface, an SD card/MMC interface, or an IR data association (IrDA) standard interface.

The audio module 280 is capable of providing bidirectional conversion between a sound and an electronic signal. At least part of the components in the audio module 280 may be included in the input/output interface 150 shown in FIG. 1. The audio module 280 is capable of processing sound information input or output through a speaker 282, a receiver 284, earphones 286, microphone 288, etc.

The camera module 291 refers to a device capable of taking both still and moving images. According to an embodiment, the camera module 291 is capable of including one or more image sensors (e.g., a front image sensor or a rear image sensor), a lens, an image signal processor (ISP), a flash (e.g., an LED or xenon lamp), etc.

The power management module 295 is capable of managing power of the electronic device 201. According to an embodiment, the power management module 295 is capable of including a power management IC (PMIC), a charger IC, or a battery or fuel gauge. The PMIC may employ wired charging and/or wireless charging methods. Examples of the wireless charging method are magnetic resonance charging, magnetic induction charging, and electromagnetic charging. To this end, the PMIC may further include an additional circuit for wireless charging, such as a coil loop, a resonance circuit, a rectifier, etc. The battery gauge is capable of measuring the residual capacity, charge in voltage, current, or temperature of the battery 296. The battery 296 takes the form of either a rechargeable battery or a solar battery.

The indicator 297 is capable of displaying a specific status of the electronic device 201 or a part thereof (e.g., the processor 210), e.g., a boot-up status, a message status, a charging status, etc. The motor 298 is capable of converting an electrical signal into mechanical vibrations, such as, a vibration effect, a haptic effect, etc. Although not shown, the electronic device 201 is capable of further including a processing unit (e.g., GPU) for supporting a mobile TV. The processing unit for supporting a mobile TV is capable of processing media data pursuant to standards, e.g., digital multimedia broadcasting (DMB), digital video broadcasting (DVB), or mediaFlo™, etc.

Each of the elements described in the present disclosure may be formed with one or more components, and the names of the corresponding elements may vary according to the type of the electronic device. In various embodiments, the electronic device may include at least one of the above described elements described in the present disclosure, and may exclude some of the elements or further include other additional elements. Further, some of the elements of the electronic device according to various embodiments may be coupled to form a single entity while performing the same functions as those of the corresponding elements before the coupling.

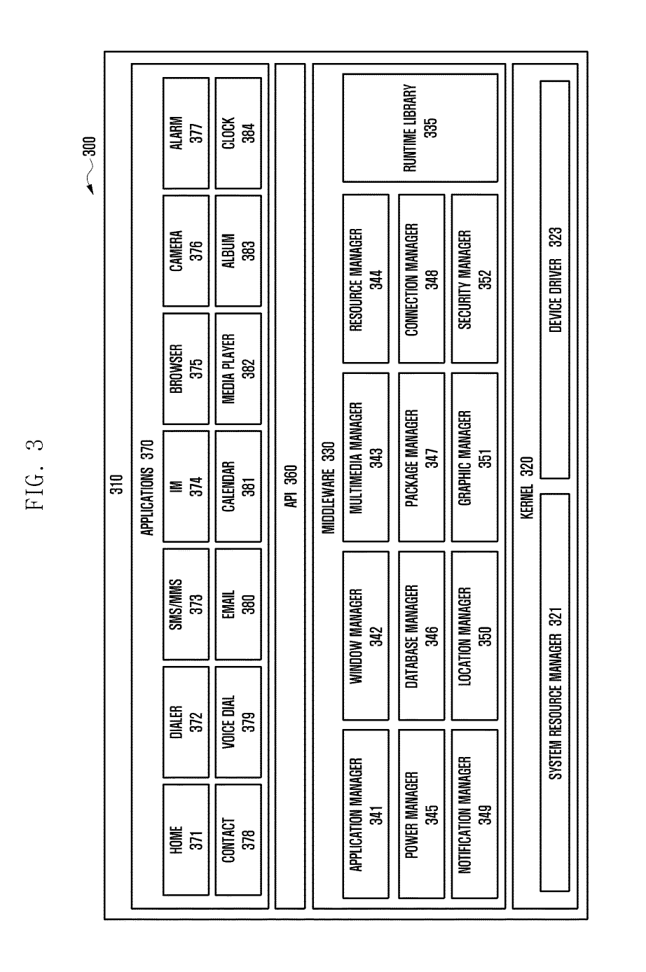

FIG. 3 is a block diagram of a programming module according to an embodiment of the present disclosure.

Referring to FIG. 3, according to an embodiment, the program module 310 (e.g., program module 140 shown in FIG. 1) is capable of including an OS for controlling resources related to the electronic device (e.g., electronic device 101) and/or various applications (e.g., application programs 147 shown in FIG. 1) running on the OS. The OS may be Android®, iOS®, Windows®, Symbian®, Tizen®, Bada®, etc.

The program module 310 is capable of including a kernel 320, middleware 330, API 360 and/or applications 370. At least part of the program module 310 may be preloaded on the electronic device or downloaded from a server (e.g., an electronic device 102 or 104, server 106, etc.).

The kernel 320 (for example, kernel 141) may include a system resource manager 321 and/or a device driver 323. The system resource manager 321 may include, for example, a process manager, a memory manager, and a file system manager. The system resource manager 321 may perform a system resource control, allocation, and recall. The device driver 323 may include, for example, a display driver, a camera driver, a Bluetooth® driver, a shared memory driver, a USB driver, a keypad driver, a Wi-Fi driver, and an audio driver. Further, according to an embodiment, the device driver 323 may include an inter-process communication (IPC) driver.

The middleware 330 may provide a function required in common by the applications 370. Further, the middleware 330 may provide a function through the API 360 to allow the applications 370 to efficiently use limited system resources within the electronic device. According to an embodiment, the middleware 330 (for example, the middleware 143) may include at least one of a runtime library 335, an application manager 341, a window manager 342, a multimedia manager 343, a resource manager 344, a power manager 345, a database manager 346, a package manager 347, a connection manager 348, a notification manager 349, a location manager 350, a graphic manager 351, and a security manager 352.

The runtime library 335 may include, for example, a library module used by a complier to add a new function through a programming language while the applications 370 are executed. According to an embodiment, the runtime library 335 executes input and output, management of a memory, a function associated with an arithmetic function and the like.

The application manager 341 may manage, for example, a life cycle of at least one of the applications 370. The window manager 342 may manage GUI resources used on the screen. The multimedia manager 343 may detect a format required for reproducing various media files and perform an encoding or a decoding of a media file by using a codec suitable for the corresponding format. The resource manager 344 manages resources such as a source code, a memory, or a storage space of at least one of the applications 370.

The power manager 345 may operate together with a basic input/output system (BIOS) to manage a battery or power and provides power information required for the operation. The database manager 346 may manage generation, search, and change of a database to be used by at least one of the applications 370. The package manager 347 may manage an installation or an update of an application distributed in a form of a package file.

The connection manager 348 may manage, for example, a wireless connection such as Wi-Fi or Bluetooth®. The notification manager 349 may display or notify a user of an event such as an arrival message, an appointment, a proximity alarm or the like, in a manner that does not disturb the user. The location manager 350 may manage location information of the electronic device. The graphic manager 351 may manage a graphic effect provided to the user or a user interface related to the graphic effect. The security manager 352 provides a general security function required for a system security or a user authentication. According to an embodiment, when the electronic device (for example, the electronic device 101) has a call function, the middleware 330 may further include a telephony manager for managing a voice of the electronic device or a video call function.

The middleware 330 is capable of including modules configuring various combinations of functions of the above described components. The middleware 330 is capable of providing modules specialized according to types of operation systems to provide distinct functions. The middleware 330 may be adaptively configured in such a way as to remove part of the existing components or to include new components.

The API 360 (for example, API 145) may be a set of API programming functions, and may be provided with a different configuration according to an OS. For example, in Android® or iOS®, a single API set may be provided for each platform. In Tizen®, two or more API sets may be provided.

The applications 370 (e.g., application programs 147) may include one or more applications for performing various functions, e.g., home 371, dialer 372, SMS/MMS 373, instant message (IM) 374, browser 375, camera 376, alarm 377, contact 378, voice dial 379, email 380, calendar 381, media player 382, album 383, clock 384, health care (e.g., an application for measuring amount of exercise, blood sugar level, etc.), and environment information (e.g., an application for providing atmospheric pressure, humidity, temperature, etc.).

According to an embodiment, the applications 370 are capable of including an application for supporting information exchange between an electronic device (e.g., electronic device 101) and an external device (e.g., electronic devices 102 and 104), which is hereafter called ‘information exchange application’). The information exchange application is capable of including a notification relay application for relaying specific information to external devices or a device management application for managing external devices.

For example, the notification relay application is capable of including a function for relaying notification information, created in other applications of the electronic device (e.g., SMS/MMS application, email application, health care application, environment information application, etc.) to external devices (e.g., electronic devices 102 and 104). In addition, the notification relay application is capable of receiving notification information from external devices to provide the received information to the user.

The device management application is capable of managing (e.g., installing, removing or updating) at least one function of an external device (e.g., electronic devices 102 and 104) communicating with the electronic device. Examples of the function are a function of turning-on/off the external device or part of the external device, a function of controlling the brightness (or resolution) of the display, applications running on the external device, services provided by the external device, etc. Examples of the services are a call service, messaging service, etc.

According to an embodiment, the applications 370 are capable of including an application (e.g., a health care application of a mobile medical device, etc.) specified attributes of an external device (e.g., electronic devices 102 and 104). According to an embodiment, the applications 370 are capable of including applications received from an external device (e.g., a server 106, electronic devices 102 and 104). According to an embodiment, the applications 370 are capable of including a preloaded application or third party applications that can be downloaded from a server. It should be understood that the components of the program module 310 may be called different names according to types of OSs.

According to various embodiments, at least part of the program module 310 can be implemented with software, firmware, hardware, or any combination of two or more of them. At least part of the program module 310 can be implemented (e.g., executed) by a processor (e.g., processor 120). At least part of the programing module 310 may include modules, programs, routines, sets of instructions or processes, etc., in order to perform one or more functions.

Various embodiments of the present disclosure provide a handheld electronic device capable of transmitting, to a card reading apparatus, card information carried by magnetic field signals, and thus making payment for costs. Various embodiments also provide a handheld electronic device capable of making payment for costs, etc., through communication with a card reading apparatus, although the apparatus is not equipped with an NFC module, without modifying the existing solution, as if a magnetic card is used against the apparatus. Therefore, the present disclosure is capable of leading to activating offline mobile payment.

The term ‘module’ as used in various embodiments of the present disclosure may mean a unit including one of hardware, software, and firmware or any combination of two or more of them. The ‘module’ may be interchangeable with the term ‘unit,’ ‘logic,’ ‘logical block,’ ‘component,’ or ‘circuit.’ The ‘module’ may be the smallest unit of an integrated component or a part thereof. The ‘module’ may be the smallest unit that performs one or more functions or a part thereof. The ‘module’ may be mechanically or electronically implemented. For example, the ‘module’ according to various embodiments of the present disclosure may include at least one of the following: application-specific IC (ASIC) chips, field-programmable gate arrays (FPGAs), and programmable-logic devices for performing certain operations, which are now known or will be developed in the future.

At least part of the method (e.g., operations) or system (e.g., modules or functions) according to various embodiments can be implemented with instructions as programming modules that are stored in computer-readable storage media. One or more processors (e.g., processor 120) can execute instructions, thereby performing the functions. An example of the computer-readable storage media may be a memory 130. At least part of the programming modules can be implemented (executed) by a processor. At least part of the programing module may include modules, programs, routines, sets of instructions or processes, etc., in order to perform one or more functions.

Examples of computer-readable media include: magnetic media, such as hard disks, floppy disks, and magnetic tape; optical media such as compact disc ROMs (CD-ROMs) and DVD; magneto-optical media, such as floptical disks; and hardware devices that are specially configured to store and perform program instructions (e.g., programming modules), such as ROM, RAM, flash memory, etc. Examples of program instructions include machine code instructions created by assembly languages, such as a compiler, and code instructions created by a high-level programming language executable in computers using an interpreter, etc. The described hardware devices may be configured to act as one or more software modules in order to perform the operations and methods described above, or vice versa.

Modules or programming modules according to various embodiments may include one or more components, remove part of them described above, or include new components. The operations performed by modules, programming modules, or the other components, according to various embodiments, may be executed in serial, parallel, repetitive or heuristic fashion. Part of the operations can be executed in any other order, skipped, or executed with additional operations.

While the present disclosure has been shown and described with reference to various embodiments thereof, it will be understood by those skilled in the art that various changes in form and details may be made therein without departing from the spirit and scope of the present disclosure as defined by the appended claims and their equivalents.

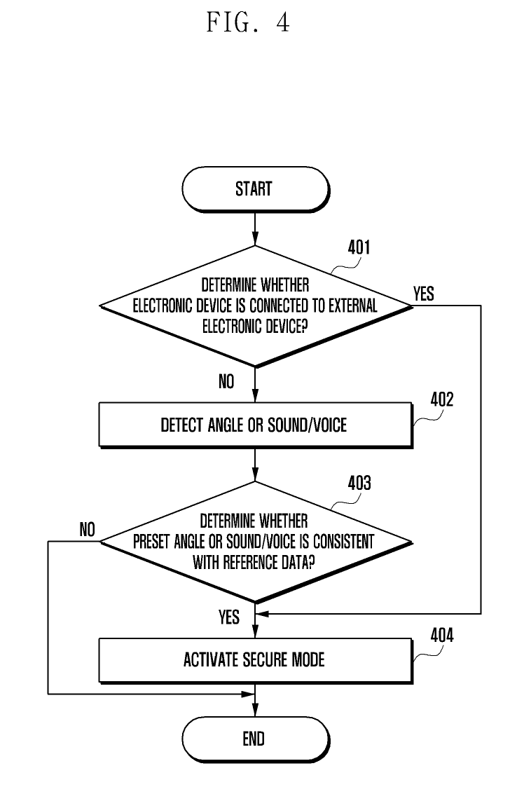

In the following description, an electronic device and a method of securing the electronic device according to various embodiments of the present disclosure are explained in detail with reference to FIGS. 4 to 10.

FIG. 4 is a flowchart that describes operations of an electronic device according to various embodiments.

With reference to FIG. 4, the electronic device is capable of determining whether it is connected to an external electronic device in operation 401. When the electronic device ascertains that it is not connected to an external electronic device in operation 401, it is capable of activating a secure mode in operation 404.

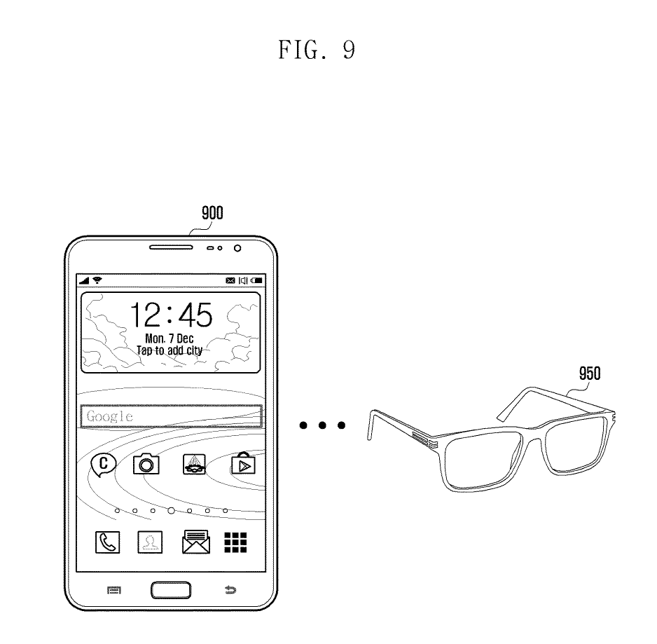

In the following embodiments, an external electronic device is referred to as an apparatus which includes a screen or a display and is configured to communicate with the electronic device. The external electronic device may be various forms of apparatuses, e.g., glasses. A detailed description of an external electronic device will be provided later with reference to FIG. 9.

On the other hand, when the electronic device ascertains that it is connected to an external electronic device in operation 401, it is capable of detecting an angle or sound/voice in operation 402. The electronic device is capable of determining whether the detected angle or sound/voice is consistent with a preset angle or sound/voice in operation 403. The preset angle or sound/voice may be reference data to use for the determination as to whether it activates a secure mode. When the electronic device ascertains that the detected angle or sound/voice is consistent with a preset angle or sound/voice, e.g., reference data, in operation 403, it is capable of activating a secure mode in operation 404. On the other hand, when the electronic device ascertains that the detected angle or sound/voice is not consistent with a preset angle or sound/voice, e.g., reference data, in operation 403, it is capable of ending the procedure.

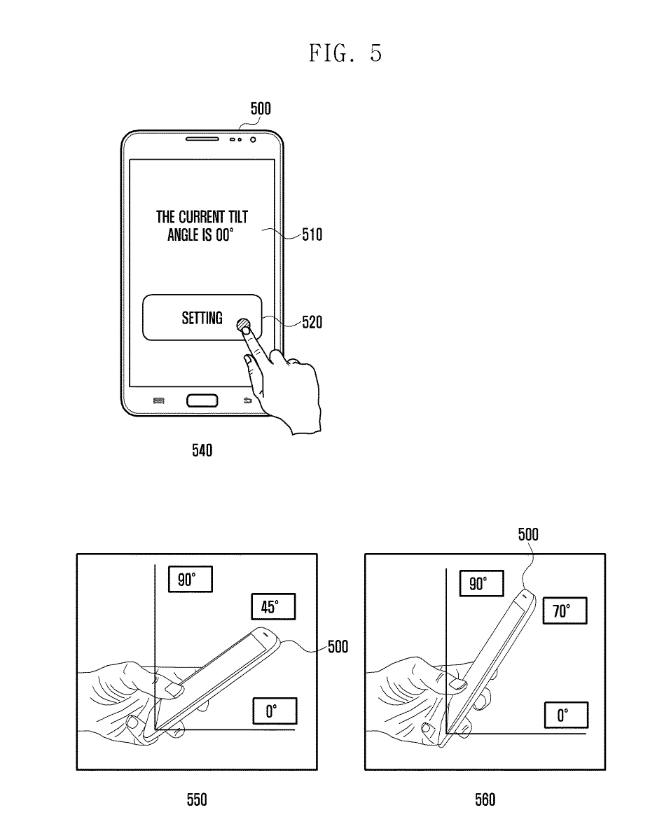

FIG. 5 shows diagrams that describe a method of setting reference data according to various embodiments of the present disclosure.

With reference to FIG. 5, the electronic device 500 is capable of including a sensor for detecting tilt. As shown in diagram 540, when the tilt sensor detects tilt of electronic device 500, it measures the tilt angle and displays a message “The current tilt angle is 00°.” for showing the measured tilt angle on the display 510. As shown in diagram 550, when the electronic device 500 is tilted at an angle of 45°, the tilt sensor measures the tilt angle and the electronic device 500 displays a message “The current tilt angle is 45°.” The electronic device 500 is capable of displaying the message and a setting button 520 for setting the measured tilt angle as reference data. When the electronic device 500 measures a tilt angle of 45° and receives an input via the setting button 520, it is capable of setting the measured 45° as reference data.

As shown in diagram 560, when the electronic device 500 is tilted at an angle of 70°, the tilt sensor measures the tilt angle and the electronic device 500 displays a message “The current tilt angle is 70°” along with a setting button 520. When the electronic device 500 measures a tilt angle of 70° and receives an input via the setting button 520, it is capable of setting the measured 70° as reference data.

In various embodiments of the present disclosure, an electronic device sets an angle for activating a secure mode as reference data, and is thus capable of detecting the change in tilt angle. When the electronic device ascertains that the measured angle (or tilt angle change) is consistent with an angle preset as reference data, it is capable of automatically activating a secure mode. In an embodiment, in a state where the electronic device ascertains that the measured angle (or tilt angle change) is consistent with an angle preset as reference data and automatically activates a secure mode, although it experiences the tilting so that its tilt angle varies, it is capable of maintaining the secure mode.

In an embodiment, in a state where the electronic device ascertains that the measured angle (or tilt angle change) is consistent with an angle preset as reference data and automatically activates a secure mode, when it receives a user's additional input, it is capable of deactivating the secure mode.

In another embodiment, in a state where the electronic device ascertains that the measured angle (or tilt angle change) is consistent with an angle preset as reference data and automatically activates a secure mode, when it re-detects an angle set as reference data, it is capable of deactivating the secure mode.

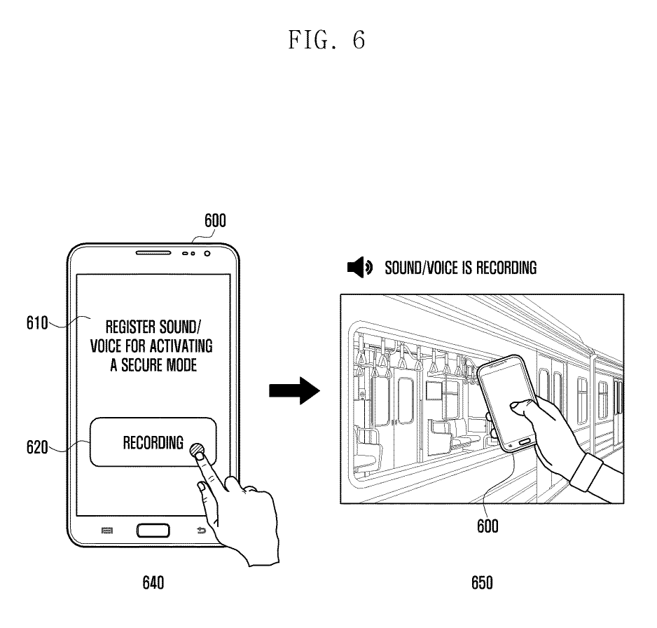

FIG. 6 shows diagrams that describe a method of setting reference data according to various embodiments of the present disclosure.

With reference to FIG. 6, the electronic device 600 is capable of including a microphone (not shown) for receiving sound/voice from the outside. As shown in diagram 640, the electronic device 600 is capable of displaying a message requesting the registration of sound/voice required to activate a secure mode on the display 610 so that the user can view it. The electronic device 600 is capable of further displaying a recording button 620 for setting sound/voice as reference data on the display, along with the request message. As shown in diagram 650, when the electronic device 600 detects a user's input via the recording button 620, it is capable of recording sound/voice input via the microphone.

In an embodiment, sound created in a subway station may be set as reference data to activate a secure mode of the electronic device. To do this, when the electronic device 600 detects a user's input via the recording button 620 in a subway station, it is capable of recording sound created in the subway station. After that, when the electronic device 600 detects the same sound as that recorded in the set subway station, it is capable of activating a secure mode. For example, when the electronic device detects sound created in a set subway station, it is capable of recognizing that the user is waiting for a subway train in a subway station.

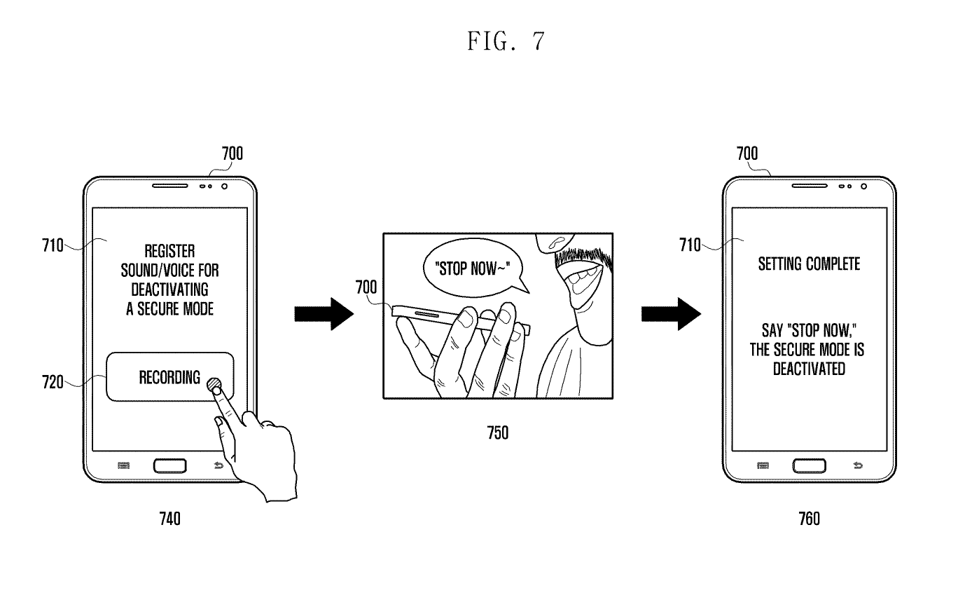

FIG. 7 shows diagrams that describe a method of setting reference data according to various embodiments of the present disclosure.

With reference to FIG. 7, the electronic device 700 is capable of including a microphone (not shown) for receiving sound/voice from the outside. As shown in diagram 740, the electronic device 700 is capable of displaying a message requesting the registration of sound/voice required to deactivate a secure mode on the display 710 so that the user can view it. The electronic device 700 is capable of further displaying a recording button 720 for setting sound/voice as reference data on the display, along with the request message. As shown in diagram 750, when the electronic device 700 detects a user's input via the recording button 720, it is capable of recording sound/voice input via the microphone. As shown in diagram 760, when the electronic device 700 has recorded sound/voice according to the execution of the recording button 720, it is capable of displaying a message informing the user that reference data for deactivating a secure mode has been set.

In an embodiment, the electronic device 700 is capable of receiving a voice for deactivating a secure mode from the user, e.g., “Stop now.” After that, when the electronic device 700 operating in a secure mode detects a voice “Stop now,” it is capable of deactivating the secure mode.

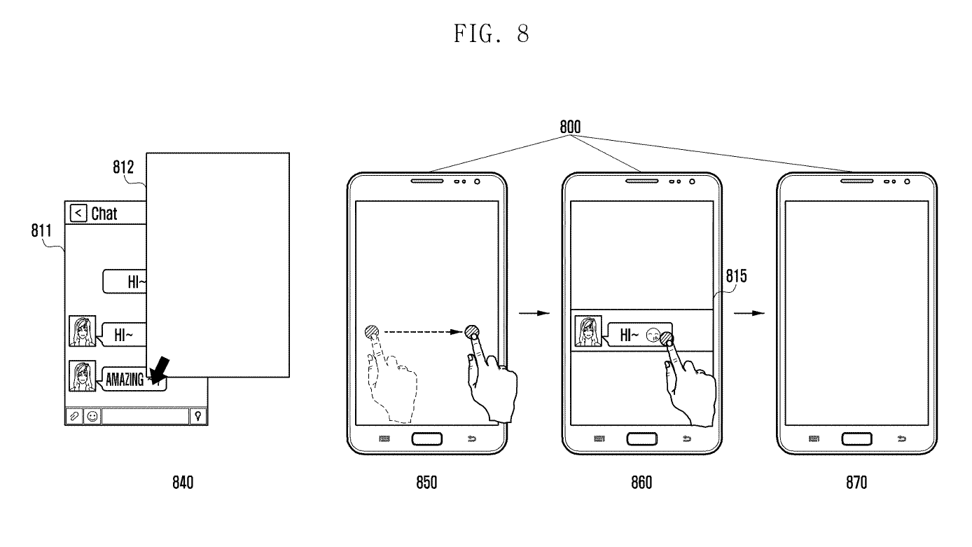

FIG. 8 shows diagrams that describe operations in a secure mode according to various embodiments.

With reference to diagram 840, when the electronic device 800 activates a secure mode, it adds and displays at least one layer onto an existing layer currently displayed, so that the added layer and existing layer overlap with each other. The added layer may cover content displayed on the existing layer so that the content cannot be shown. In another embodiment, the added layer may semi-transparently cover content displayed on the existing layer. In another embodiment, the added layer may cover part of the content displayed on the existing layer. In the following description, the existing displayed layer is called a first layer 811 and the added layer is called a second layer 812.

With reference to diagram 850, the electronic device 800 is capable of displaying the second layer 812 on the first layer 811. As shown in diagram 850, the second layer 812 may be a layer covering content displayed on the first layer 811. The electronic device 800 is capable of detecting a user's touch and/or drag actions on the screen. In an embodiment, the electronic device 800 is capable of detecting touch and/or drag actions which may be created by a tool such as a digital pen, a user's body such as fingers, etc.

As shown in diagram 860, when the electronic device 800 detects a user's drag action, it is capable of displaying at least part 815 of the content of the first layer 811 according to the path of the drag action input via the second layer 812.

As shown in diagram 870, when the electronic device 800 detects the releases of the user's input, it is capable of controlling the second layer 812 not to show at least part 815 of the content of the first layer 811 which has been displayed through the second layer 812 according to the path of a user's drag action, i.e., to return to the previous state as before the input of the user's drag action.

In another embodiment, when a period of time has elapsed since the electronic device 800 detected the release of a user's input, the electronic device 800 is capable of controlling the second layer 812 not to show at least part 815 of the content of the first layer 811 which has been displayed through the second layer 812 according to the path of a user's drag action, i.e., to return to the previous state as before the input of the user's drag action.

In another embodiment, when a period of time set by a user has elapsed since the electronic device 800 detected the release of a user's input, the electronic device 800 is capable of controlling the second layer 812 not to show at least part 815 of the content of the first layer 811 which has been displayed through the second layer 812 according to the path of a user's drag action, i.e., to return to the previous state as before the input of the user's drag action.

FIG. 9 shows an electronic device and an external electronic device according to various embodiments.

With reference to FIG. 9, the electronic device 900 is capable of detecting the connection with an external electronic device 950. The electronic device 900 is capable of connecting to an external electronic device 950 via Bluetooth® communication, etc.

In various embodiments, the external electronic device 950 is referred to as wearable devices on a user's body. An example of the external electronic device 950 is an electronic device in the form of a pair of eyeglasses. When the electronic device 900 is connected to the external electronic device 950 in the form of a pair of eyeglasses, it is capable of activating a secure mode. When the electronic device 900 is connected to the external electronic device 950, the electronic device 900 is capable of controlling the display of content displayed on the external electronic device 950, which differs from content displayed on the electronic device 900.

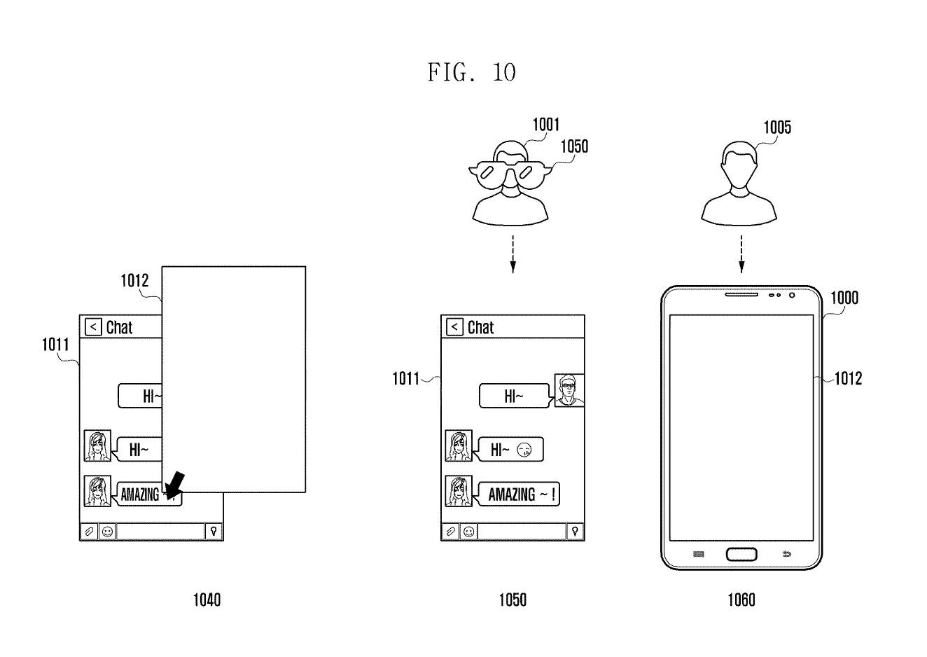

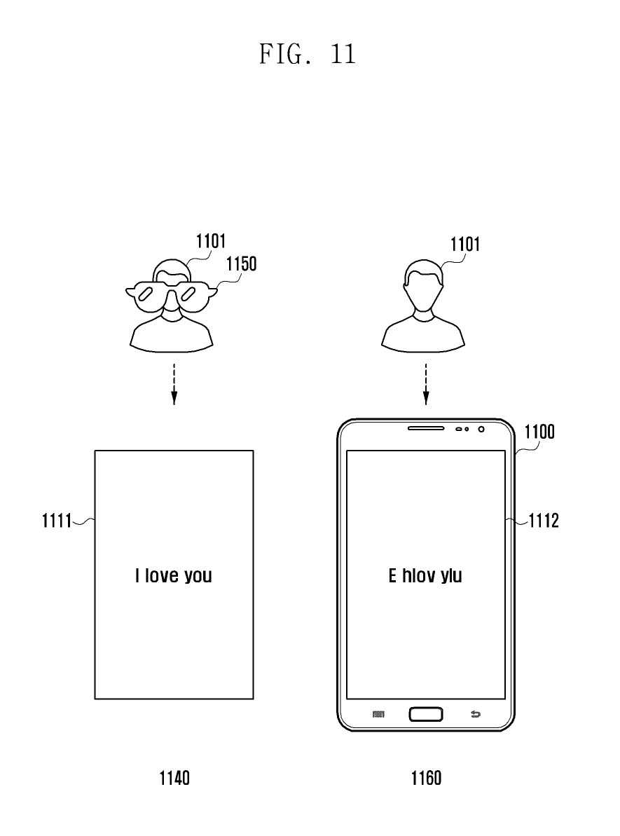

In various embodiments of the present disclosure, the electronic device 900 is capable of previously registering the external electronic device 950 as a device to activate a secure mode. In this case, when the electronic device 900 is connected with the registered external electronic device 950, it is capable of activating a secure mode. A description will be explained, in detail, below, with reference to FIGS. 10 and 11.

FIG. 10 shows diagrams that describe operations of an electronic device connected to an external electronic device according to various embodiments.

With reference to diagram 1040, when the electronic device 1000 detects the connection with an external electronic device 1050, it is capable of activating a secure mode. In a secure mode, the electronic device 1000 is capable of additionally displaying at least one layer on an existing displayed layer, overlapping with each other. The added layer may cover content of the existing displayed layer so that the content cannot be shown. In another embodiment, the added layer may semi-transparently cover content of the existing displayed layer. In another embodiment, the added layer may cover part of the content of the existing displayed layer. In the following description, the existing displayed layer is called a first layer 1011 and the added layer is called a second layer 1012.

With reference to diagram 1050, the external electronic device 1050 connected to the electronic device 1000 is capable of displaying content of the first layer 1011 on its screen. In this case, the user 1001 using/wearing the external electronic device 1050 can view the content of the first layer 1011, instead of the second layer 1012.

With reference to diagram 1060, the electronic device 1000 connected to the external electronic device 1050 is capable of displaying the second layer 1012 covering the first layer 1011 on its screen, overlapping with each other. In this case, a third party 1005 who does not use/wear the external electronic device 1050 cannot view the content of the first layer 1011.

In various embodiments, the electronic device 1000 connected to the external electronic device 1050 is capable of detecting inputs that the user 1001 applies to on its screen. When the electronic device 1000 detects a touch action and/or a drag action of the user 1001 on its screen, it is capable of applying the detected touch and/or drag actions (action) to content of the first layer 1011. In an embodiment, while a user 1011 using/wearing the external electronic device 1050 views the content of the first layer 1011 displayed on the screen of the external electronic device 1050, the user 1011 can input a touch action and/or a gesture to the screen of the electronic device 1000, and alter the content of the first layer 1011.

FIG. 11 shows diagrams that describe operations of an electronic device connected to an external electronic device according to various embodiments.

With reference to diagram 1140, when the electronic device 1100 detects the connection with an external electronic device 1150, it is capable of activating a secure mode. The external electronic device 1150 connected to the electronic device 1100 is capable of displaying, on its screen 1111, content to be displayed on the electronic device 1100. In this case, the user 1101 using/wearing the external electronic device 1150 can view the content to be displayed on the electronic device 1100, via the screen 1111 of the external electronic device 1150.

With reference to diagram 1160, the electronic device 1100 connected to the external electronic device 1150 is capable of displaying, on its screen 1112, content which differs from content displayed on the external electronic device 1150.

In various embodiments, when the electronic device 1100 displays content which differs from content displayed on the external electronic device 1150, e.g., text, it is capable of: creating its content, by adding or subtracting a specific value to or from ASCII or Unicode values of the content displayed on the external electronic device 1150 or by applying an equation to the content; and displaying the content that differs from the content displayed on the external electronic device 1150.

In another embodiment, when content is text, the electronic device 1100 is capable of storing a table matching one text with another text in the memory. The electronic device 1100 is capable of displaying content which differs from that displayed on the external electronic device 1150, based on the stored table.

When content is an image, the electronic device 1100 is capable of transforming x- and y-coordinates of the image into y- and x-coordinates and displaying the transformed image, thereby displaying the content which differs from that displayed on the external electronic device 1150. Alternatively, the electronic device 1100 is capable of displaying an image with top/bottom reversal, left/right reversal, etc., thereby displaying the content which differs from that displayed on the external electronic device 1150.

In various embodiments, the electronic device 1100 connected to the external electronic device 1150 is capable of detecting inputs that the user applies to on its screen 1112. When the electronic device 1100 detects a touch action and/or a drag action of the user on its screen 1112, it is capable of applying the detected touch and/or drag actions (action) to content displayed on the external electronic device 1150.

In an embodiment, while a user 1101 using/wearing the external electronic device 1150 views content displayed on the screen 1111 of the external electronic device 1150, the user 1101 can input a touch action and/or a gesture to the screen 1112 of the electronic device 1100, and alter the content displayed on the screen 1111. The user 1101 uses/wears the external electronic device 1150 and thus undergoes the same experience as if he/she uses the electronic device 1100.

The electronic device securing method according to various embodiments enables an electronic device to activate a secure mode and thus to secure content displayed on the screen from other nearby users.

As described above, embodiments of the method of securing an electronic device and electronic devices adapted to the method are described with reference to the accompanying drawings. The terms and words used in the description and the drawings are not limited to the bibliographical meanings, but, are merely used by the inventor to enable a clear and consistent understanding of the present disclosure. Accordingly, it should be apparent to those skilled in the art that the description of various embodiments of the present disclosure is provided for illustration purpose only and not for the purpose of limiting the present disclosure as defined by the appended claims and their equivalents.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method of securing an electronic device, the method comprising:
displaying content;
recognizing at least one of a tilt, a sound, or a voice;
comparing preset reference data to at least one of an angle corresponding to the tilt, data corresponding to the sound, or data corresponding to the voice; and
activating a secure mode for the displayed content, when the at least one of the angle corresponding to the tilt, the data corresponding to the sound, or the data corresponding to the voice is consistent with the preset reference data.

2. The method of claim 1, wherein the preset reference data comprises at least one of:
data set as a reference angle corresponding to a reference tilt of the electronic device;
data corresponding to a voice input or a sound input; or
stored sound and voice data.

3. The method of claim 1, wherein activating the secure mode for the displayed content comprises:
covering at least a first part of the content previously displayed by adding a layer over the at least the first part of the content;
detecting a touch or a gesture input on the added layer; and
showing at least a second part of the content through a path or an area corresponding to the detected touch or gesture input.

4. The method of claim 3, wherein covering the at least a first part of the content comprises:
displaying different content on the added layer, the different content being irrelevant to the content previously displayed.

5. The method of claim 1, further comprising:
deactivating the secure mode,
wherein deactivating the secure mode occurs in response to at least one of:
a passage of a threshold period of time since the secure mode was activated; or
an input of data that is consistent with the reference data.

6. An electronic device comprising:
a display module configured to display content;
a sensor module including a sensor, the sensor configured to detect a tilt of the electronic device;
an audio module including a microphone, the microphone configured to receive at least one of sound input or voice input; and
a processor configured to:
compare preset reference data to at least one of
an angle corresponding to the detected tilt,
data corresponding to the received sound input, or
data corresponding to the received voice input; and
activate a secure mode for the displayed content, when the at least one of the angle corresponding to the tilt, the data corresponding to the sound, or the data corresponding to the voice is consistent with the preset reference data.

7. The electronic device of claim 6, wherein the preset reference data comprises at least one of:
data set as a reference angle corresponding to a reference tilt of the electronic device;
data corresponding to a voice input or a sound input; and
stored sound and voice data.

8. The electronic device of claim 6, wherein the processor is configured to:
cover at least a first part of the content previously displayed by adding a layer over the at least the first part of the content;
detect a touch or a gesture input on the added layer; and
show at least a second part of the content through a path or an area corresponding to the detected touch or gesture input.

9. The electronic device of claim 8, wherein the processor is configured to display different content on the added layer, the different content being irrelevant to the content previously displayed.

10. The electronic device of claim 6, wherein the processor is further configured to deactivate the secure mode,
wherein the processor is configured to deactivate the secure mode, in response to an occurrence of at least one of:
a passage of a threshold period of time since the secure mode was activated; or
an input of data that is consistent with the reference data.

11. A method of securing an electronic device, the method comprising:
displaying content;
recognizing a connection with an external electronic device; and
activating a secure mode for the displayed content, when the electronic device is connected with the external electronic device.

12. The method of claim 11, wherein activating the secure mode comprises:
activating the secure mode in response to the external electronic device having been registered in the electronic device.

13. The method of claim 11, wherein activating the secure mode comprises:
requesting the connected external electronic device to display the content; and
altering and displaying the altered content on the connected external electronic device.

14. The method of claim 11, wherein activating the secure mode for the displayed content comprises:
covering at least a first part of the content previously displayed by adding a layer over the at least the first part of the content; and
requesting the connected external electronic device to display the content having the added layer.

15. The method of claim 11, further comprising:
when a condition for deactivating the secure mode is satisfied, deactivating the secure mode.

16. An electronic device comprising:
a display module configured to display content; and
a processor configured to:
recognize a connection with an external electronic device; and
activate a secure mode for the displayed content, when the electronic device is connected with the external electronic device.

17. The electronic device of claim 16, wherein the processor is configured to activate
the secure mode in response to the external electronic device having been registered in the electronic device.

18. The electronic device of claim 16, wherein the processor is configured to:
request the connected external electronic device to display the content; and
alter and display the altered content on the connected external electronic device.

19. The electronic device of claim 16, wherein the processor is configured to:
cover at least a first part of the content previously displayed by adding a layer over the at least the first part of the content; and
request the connected external electronic device to display the content having the added layer.

20. The electronic device of claim 16, wherein the processor is configured to:
ascertain whether a condition for deactivating the secure mode is satisfied; and
in response to ascertaining the condition is satisfied, deactivate the secure mode.
